(19) United States
(12) Patent Application Publication
(10) Pub. No.: US 2024/0079743 A1
(43) Pub. Date: Mar. 7, 2024

(54) BATTERY TERMINAL AND BATTERY USING THE SAME

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Shigeru MATSUMOTO, Toyohashi-shi (JP); Yozo UCHIDA, Toyota-shi (JP); Yuki SATO, Toyota-shi (JP); Tsuyoshi EHARA, Toyota-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/341,270

(22) Filed: Jun. 26, 2023

(30) Foreign Application Priority Data
Sep. 1, 2022 (JP) 2022-139455

(51) Int. Cl. H01M 50/557; H01M 50/103; H01M 50/209; H01M 50/507

(52) U.S. Cl. CPC H01M 50/557; H01M 50/103; H01M 50/209; H01M 50/507

(57) ABSTRACT

A battery terminal has a two-piece configuration of different types of conductive materials. A first piece placed outside and a second piece placed inside with including a current collecting portion are fixed in two portions of a first fixing portion and a second fixing portion. The first fixing portion is positioned between the current collecting portion and the second fixing portion in a longitudinal direction in a shape of the terminal. Leaning of the current collecting portion with respect to a center in a short-side direction and leaning of the first fixing portion with respect to a center are opposite to each other.

### CROSS-REFERENCE TO RELATED APPLICATIONS

This application is based upon and claims the benefit of priority from the prior Japanese Patent Application No. 2022-139455 filed on Sep. 1, 2022, the entire contents of which are incorporated herein by reference.

### BACKGROUND

### Technical Field

The present disclosure relates to a battery terminal. The present disclosure also relates to a battery using the battery terminal.

### Related Art

Heretofore, terminals, each of which penetrates through a hole provided in an exterior body, have been used for batteries. In a battery described in Japanese Patent Application Publication No. 2021-086813, such a terminal is placed to penetrate through a hole in an exterior body. In such a configuration, an insulator is integrally formed to fill a gap between the terminal and the hole in the exterior body. The terminal is connected to an electrode body in the exterior body.

### SUMMARY

Technical Problems

The above-mentioned conventional technique has a possibility that the terminal could get damaged. This is because the terminal suffers from stress such as thermal stress in connecting process of a bus bar and vibration stress during travelling after being mounted on a vehicle after the terminal has been placed in the hole of the exterior body. Especially when the terminal itself is configured as a two-piece configuration in which two components are connected, the stress tends to concentrate on a joint portion of the components.

The present disclosure has been made for the purpose of solving the problem of the above-mentioned conventional technique. Specifically, the purpose is to provide a battery terminal having excellent stress resistance and a battery using the battery terminal.

### Means of Solving the Problems

A battery terminal according to one aspect of the present disclosure is a battery terminal for connecting a power generation element placed inside an exterior body of a battery and an external conductive member placed outside the exterior body, the battery terminal being configured as a two-piece configuration including a first piece and a second piece which are formed of different conductive materials, wherein the first piece includes: a first plate-like portion provided with a first face and a second face, the first face to be arranged to face outward in the battery and to be connected to the external conductive member; and a first fixing portion and a second fixing portion provided on the second face of the first plate-like portion and fixing the second piece, the second piece includes: a second plate-like portion provided with a first face and a second face, having a shape with a longitudinal direction and a short-side direction in planar view, and formed with a first hole portion and a second hole portion, the first face being arranged to face the second face of the first plate-like portion; and a current collecting portion which is connected to a position leaning to one side from a center both in the longitudinal direction and in the short-side direction on the second face of the second plate-like portion and to be connected to the power generation element, the first fixing portion includes: a first columnar portion positioned in the first hole portion; and a first disk portion expanding wider than the first columnar portion on the second face of the second plate-like portion, the second fixing portion includes: a second columnar portion positioned in the second hole portion; and a second disk portion expanding wider than the second columnar portion on the second face of the second plate-like portion, any one of at least a part of the first disk portion and at least a part of the second disk portion is joined to the second face of the second plate-like portion, a center of the first hole portion is positioned between a center of a joint of the current collecting portion and a center of the second hole portion with respect to a longitudinal direction of the second plate-like portion, and the center of the joint of the current collecting portion leans away from a central position of the short-side direction of the second plate-like portion, and the center of the first hole portion leans away from the central position of the short-side direction of the second plate-like portion oppositely to the center of the joint of the current collecting portion. In the battery terminal according to the above aspect, the first piece of the two-piece configuration is placed to face partly outward and the second piece is placed inside the exterior body of the battery. The first plate-like portion of the first piece and the second plate-like portion of the second piece are fixed by the first fixing portion and the second fixing portion which are provided in the first plate-like portion and by the first hole portion and the second hole portion which are provided in the second plate-like portion. Location of the current collecting portion and location of the first fixing portion are deviated oppositely from each other with respect to the short-side direction of the second plate-like portion, and thereby connection of the first piece and the second piece is achieved with stress resistance.

### BRIEF DESCRIPTION OF THE DRAWINGS

FIG. 1 is an external perspective view of a battery in an embodiment;

FIG. 2 is a perspective view of a lid and an external terminal of the battery in

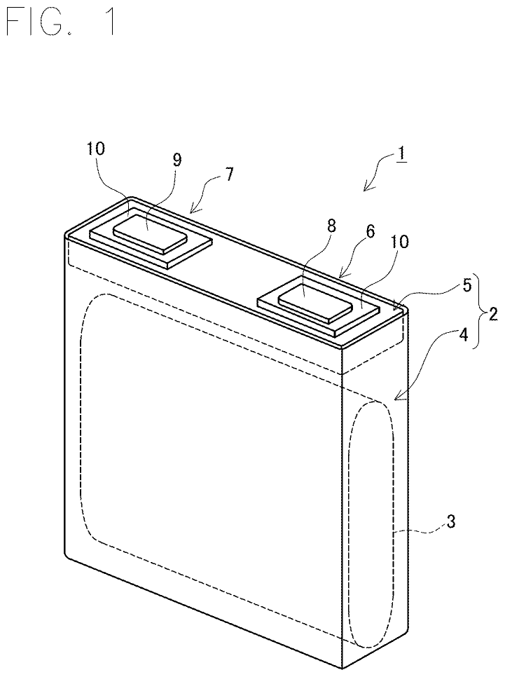

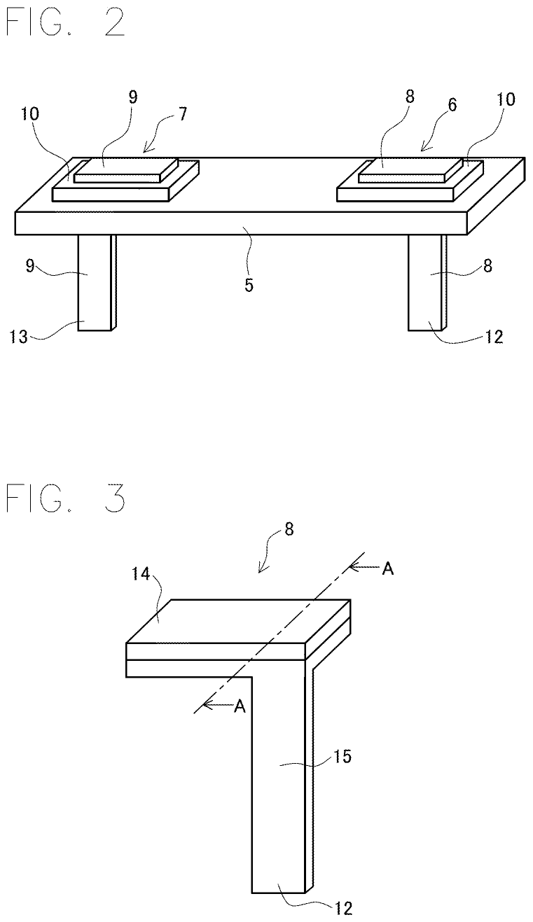

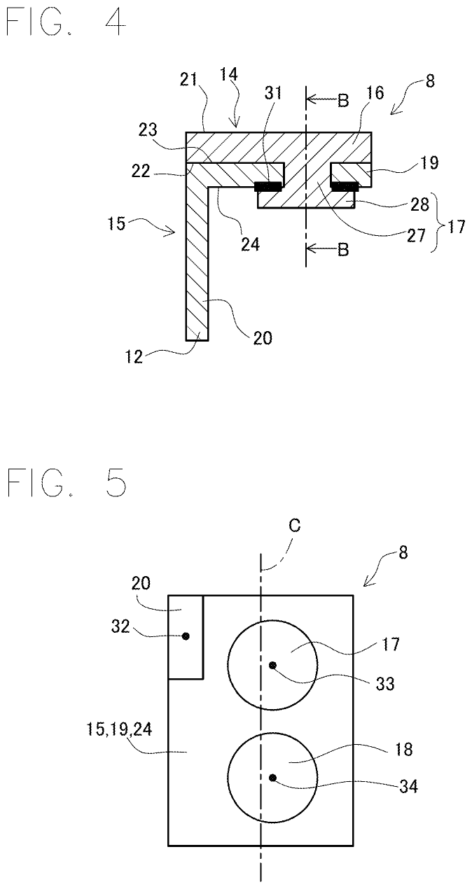

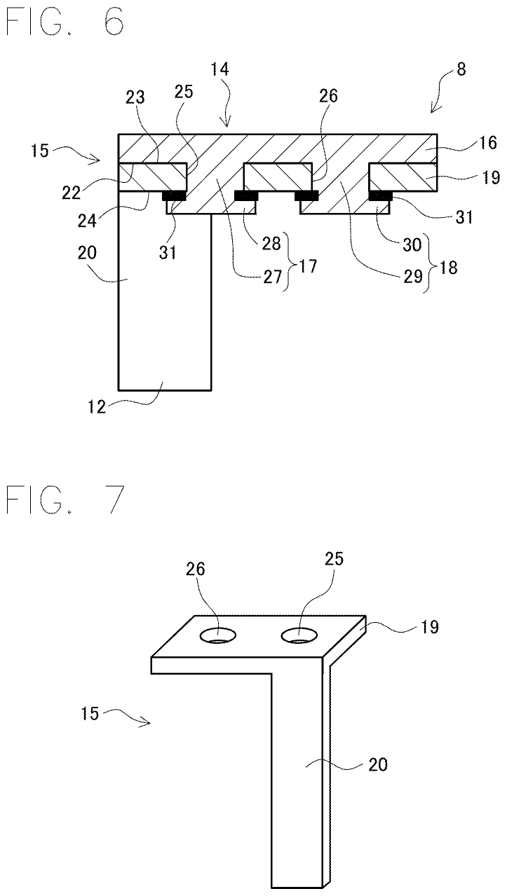

FIG. 1;

FIG. 3 is a perspective view of a battery terminal in the embodiment;

FIG. 4 is a sectional view of the battery terminal in FIG. 3;

FIG. 5 is a bottom view of the battery terminal in FIG. 3;

FIG. 6 is another sectional view of the battery terminal in FIG. 3;

FIG. 7 is a perspective view of a second piece as a single component;

FIG. 8 is a diagram for explaining a state in which a downward force is applied to the second piece;

FIG. 9 is a diagram for explaining a state in which an outward force is applied to the second piece;

FIG. 10 is a graph showing results of a simulation related to a size of moment that is applied to a fixing portion;

FIG. 11 is a perspective view of a battery stack utilizing a bus bar;

FIG. 12 is a sectional view of a state in which bus-bar welding is performed; and

FIG. 13 is a bottomed view of a battery terminal according to a modified example.

### DETAILED DESCRIPTION OF THE EXEMPLARY EMBODIMENTS

An embodiment embodying the present disclosure is explained below in detail with reference to the accompanying drawings. The present embodiment is an embodiment of the present disclosure embodied with a battery terminal used for a terminal portion of a battery and a battery using the same. A battery 1 according to the present embodiment is, as shown in FIG. 1, configured such that a power generation element 3 is housed inside an exterior body 2.

The exterior body 2 is configured with a casing 4 and a lid 5. The battery 1 has an outer shape of a flat rectangular plate-like shape as a whole. The lid 5 on an upper part of the battery 1 is provided on both end portions in the longitudinal direction with a negative external terminal part 6 and a positive external terminal part 7. A battery terminal 8 is attached at the external terminal part 6 through an insulator 10, and a battery terminal 9 is attached at the external terminal part 7 through another insulator 10. The battery terminal 8 of the external terminal part 6 and the battery terminal 9 of the external terminal part 7 are connected to a negative electrode plate and a positive electrode plate of the power generation element 3, respectively, in the exterior body 2. Bus bars 11 are to be attached to the battery terminal 8 and the battery terminal 9 of the battery 1 in FIG. 1 as explained later.

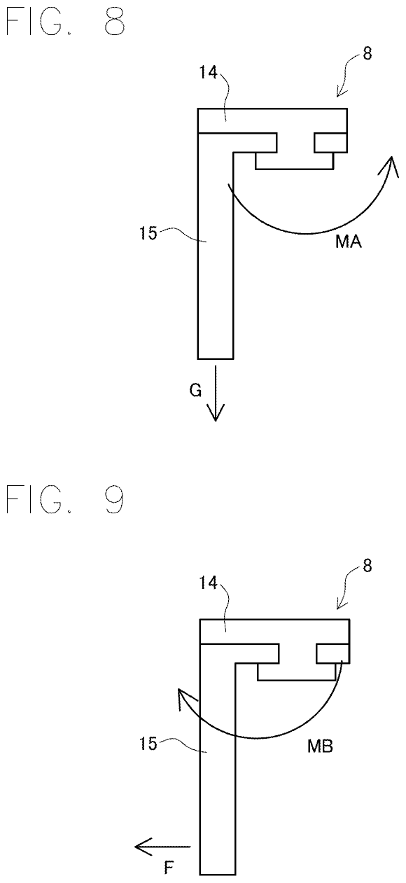

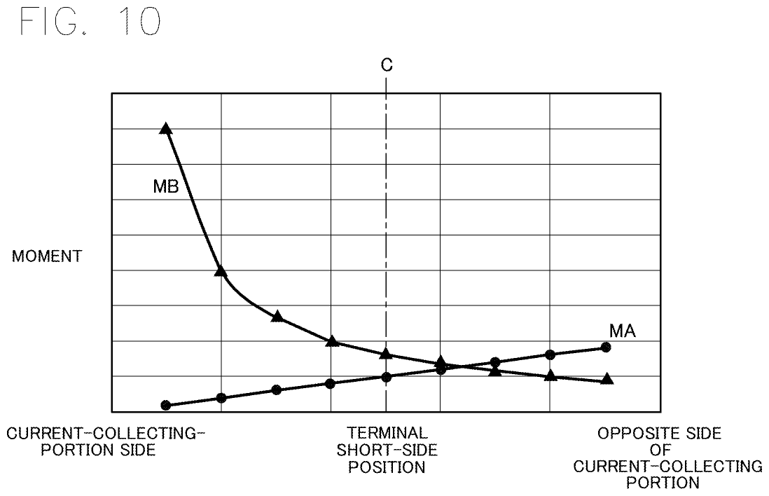

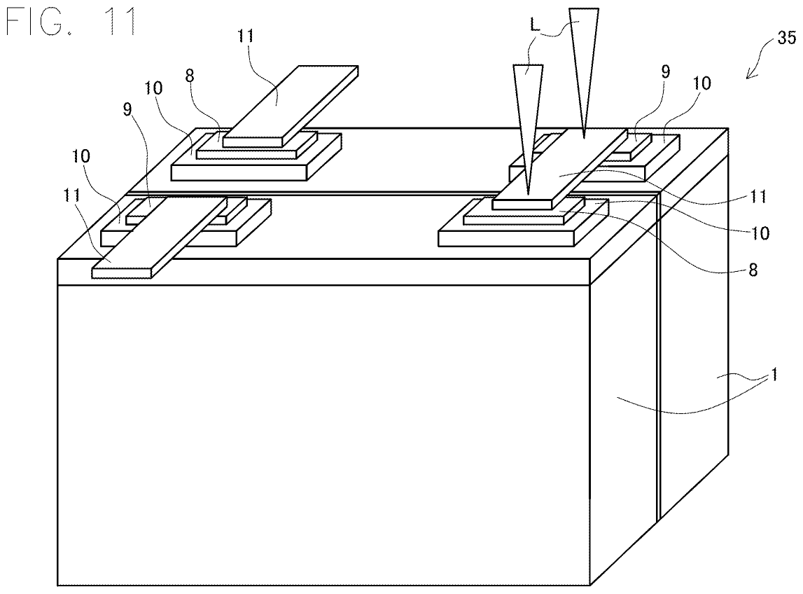

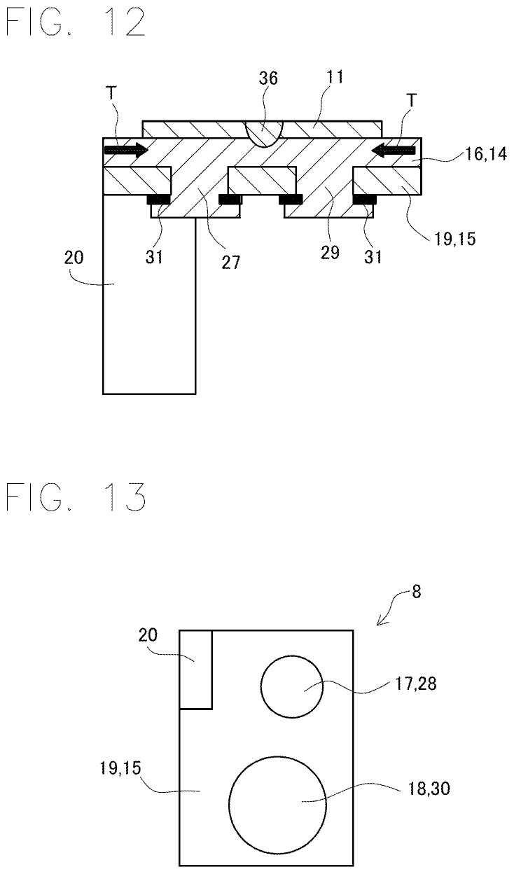

The lid 5, the external terminal part 6, and the external terminal part 7 of the battery 1 shown in FIG. 1 are illustrated in FIG. 2. A configuration in FIG. 2 shows a state in which the battery terminal 8 and the battery terminal 9 are attached to the lid 5 and fixed by the insulators 10. Portions of the external terminal part 6 and the external terminal part 7 within the lid 5 are formed with through holes so that the battery terminal 8 and the battery terminal 9 penetrate through those holes to be placed in the lid 5. The power generation element 3 is attached to a lower end portion 12 of the battery terminal 8 and a lower end portion 13 of the battery terminal 9 in FIG. 2. Then, the battery 1 shown in FIG. 1 is obtained by housing the power generation element 3 in the casing 4 and joining the lid to the casing 4.

Among components of the battery terminal 8 and the battery terminal 9, the battery terminal 8 which is to be used for a negative electrode is shown in FIG. 3. The battery terminal 8 is a component of two-piece configuration including a first piece 14 on an upper side and a second piece 15 on a lower side. The first piece 14 and the second piece 15 are configured by different types of conductive materials. Herein, the first piece 14 is made of aluminum and the second piece 15 is made of copper. The lower end portion 12 connected with the power generation element 3 is a part of the second piece 15.

A sectional view of the battery terminal 8 is shown in FIG. 4. FIG. 4 is a sectional view taken along a line A-A in FIG. 3. This section is in parallel to a short side of the lid 5. As shown in FIG. 4, in the battery terminal 8, the first piece 14 includes a first plate-like portion 16 and a fixing portion 17, and the second piece 15 includes a second plate-like portion 19 and a current collecting portion 20.

The first piece 14 has a first face 21 on the first plate-like portion 16 to face outward in the battery 1. The fixing portion 17, which is invisible in FIG. 3, is a portion to fix the second piece 15 to the first piece 14. The fixing portion 17 is provided on a second face 22 of the first plate-like portion 16. The first plate-like portion 16 is also a portion to be connected with the bus bar 11.

In the second piece 15, the second plate-like portion 19 is a plate-like portion overlapped with the first plate-like portion 16. A first face 23 of the second plate-like portion 19 faces to the second face 22. The current collecting portion 20 is provided continuing down below a second face 24 of the second plate-like portion 19. The lower end portion 12 of the current collecting portion 20 is a portion to be connected to a negative electrode plate of the power generation element 3.

A bottomed view of the battery terminal 8 seen from a lower side is shown in FIG. 5. An upper and lower direction of FIG. 5 is the longitudinal direction of the second plate-like portion 19, that is in parallel to a long side of the lid 5. A left and right direction of FIG. 5 is a short-side direction of the plate-like portion 19, that is in parallel to a short side of the lid 5. As clear from FIG. 5, the current collecting portion 20 is provided in continuous with the second plate-like portion 19 at a position leaning to one side from a center in both the longitudinal direction and the short-side direction in FIG. 5.

A sectional view of the battery terminal 8 in another section is shown in FIG. 6. FIG. 6 is a sectional view taken along a line B-B in FIG. 4. This section is in parallel with the long side of the lid 5. FIG. 7 shows the second piece 15 as a single body. As clear from FIG. 5 and FIG. 6, the fixing portion 17 shown in FIG. 4 actually includes two portions of a first fixing portion 17 and a second fixing portion 18. The first fixing portion 17 and the second fixing portion 18 are arranged in series in the longitudinal direction of the first plate-like portion 16 which is aligned with the longitudinal direction of the second plate-like portion 19.

As shown in FIG. 6 and FIG. 7, the second plate-like portion 19 is formed with a first hole portion 25 and a second hole portion 26. The first hole portion 25 and the second hole portion 26 are holes through which the first fixing portion 17 and the second fixing portion 18 penetrate, respectively. The first fixing portion 17 includes a first columnar portion 27 and a first disk portion 28, and the second fixing portion 18 includes a second columnar portion 29 and a second disk portion 30.

The first columnar portion 27 and the second columnar portion 29 are positioned inside the first hole portion 25 and the second hole portion 26, respectively. The first disk portion 28 and the second disk portion 30 are portions expanding wider than the first columnar portion 27 and the second columnar portion 29 on the second face 24. The first disk portion 28 and the second disk portion 30 continue to the second face 22 by way of the first columnar portion 27 and the second columnar portion 29, respectively.

The first fixing portion 17 and the second fixing portion 18 have originally been provided without the first disk portion 28 and the second disk portion 30 but only with the first columnar portion 27 and the second columnar portion 29, each of which is a rivet-like shape with a length longer than a thickness of the second plate-like portion 19. The battery terminal 8 has been integrated in a manner that the first face 23 is overlapped on the second face 22 and the first disk portion 28 and the second disk portion 30 are formed by riveting process. The first piece 14 is made of aluminum, and thus the piece is easy for riveting. After the riveting process, at least a part of any one or both of the first disk portion 28 and the second disk portion 30 is joined to the second face 24 by ultrasonic welding or other methods. A joint portion 31 of the second face 24 with the first disk portion 28 or the second disk portion 30 is indicated with a bold line in FIG. 4 showing a case of joining the first disk portion 28 and indicated with plural bold lines in FIG. 6 showing a case of joining both the disk portions.

In FIG. 5, a center 32 of a joint of the current collecting portion 20, a center 33 of the first hole portion 25, and a center 34 of the second hole portion 26 are indicated. Positional relations of these centers are explained. There are two positional relations of a positional relation in the longitudinal direction (which is, the upper and lower direction) and a positional relation in the short-side direction (which is, the left and right direction) of the second plate-like portion 19 with regard to these three center positions.

The positional relation in the longitudinal direction is now explained. With respect to the longitudinal direction, the center 33 of the first hole portion 25 is positioned between the center 32 of the joint of the current collecting portion 20 and the center 34 of the second hole portion 26. In FIG. 5, the center 32, the center 33, and the center 34 are arranged in this order from an upper side. This means that the first fixing portion 17 and the second fixing portion 18 are located in different positions in the longitudinal direction. Joint portions for connecting the first piece 14 and the second piece 15 are arranged in different positions in the longitudinal direction, and thus this configuration is advantageous in view of joint strength as compared with a case of arranging two joint portions close to each other.

The positional relation in the short-side direction is explained. As mentioned above, the center 32 of the joint of the current collecting portion 20 is arranged to lean to one side from a central position C in the short-side direction. In FIG. 5, the center 32 leans leftward from the central position C. On the other hand, the center 33 of the first hole portion 25 leans oppositely from the center 32 with respect to the central position C. In FIG. 5, the center 33 leans rightward from the central position C. Further, in FIG. 5, the center 34 of the second hole portion 26 also leans rightward as similar to the center 33.

The meaning of the configuration that the center 32 of the joint of the current collecting portion 20 and the center 33 of the first hole portion 25 lean oppositely each other with respect to the central position C is explained. The meaning of this leaning is to reduce the stress to be imposed to the battery terminal 8 in later processes. The battery terminal 8 may be applied with the stress on the second piece 15 in later processes. For example, there is a case that the second piece 15 is subjected to a force G in a vertical direction to pull the piece downward as shown in FIG. 8. In this case, there is generated a counter-clockwise moment MA in FIG. 8 applied to the first fixing portion 17. This generation of the moment MA as shown in FIG. 8 may happen depending on a weight of the power generation element 3 after attaching the power generation element 3 and before inserting the power generation element 3 into the casing 4, for example. In another example, there is a case that the second piece 15 is subjected to a force F in a horizontal direction to pull the piece outward. In this case, there is generated a clockwise moment MB as shown in FIG. 9 applied to the first fixing portion 17. This generation of the moment MB as shown in FIG. 9 may happen when the power generation element 3 is to be inserted into the casing 4, for example.

Magnitudes of the moment MA and the moment MB in the above cases are largely influenced by the position of the center 33 of the first hole portion 25 in the above-mentioned short-side direction. This is because a distance of the center 33 with respect to a fulcrum depends on the position of the center 33 in the short-side direction. Results of a simulation test performed by the present inventors related to the moment and the distance of the center 33 is shown in FIG. 10. A lateral axis in a graph of FIG. 10 indicates a position of the center 33 in the short-side direction. A left side in the graph corresponds to left-side leaning in FIG. 5, i.e., leaning to the same side with the current collecting portion 20. A right side in the graph corresponds to right-side leaning in FIG. 5, i.e., leaning to the opposite side from the current collecting portion 20. A vertical axis in FIG. 10 indicates the magnitude of the moment MA and the moment MB. For performing the simulation, the force G and the force F are set to be invariant.

In FIG. 10, there is a difference in line shape of the graph of the moment MA and the graph of the moment MB. Firstly, in taking a look at the graph of the moment MA, the graph depicts a gradually increasing shape. In other words, as long as the force G is invariant, the moment MA is smaller as the center 33 is leaning to the left side, and the moment MA is larger as the center 33 is leaning to the right side. The moment MA is actually large in case of leaning to the right-side, but the difference level is just a little.

On the other hand, the graph of the moment MB has an inclination oriented inversely as a whole from the inclination of the moment MA. Furthermore, the graph of the moment MB in a left region with respect to a center of the graph has steep inclination which becomes steeper as coming close to the left side in the graph. Accordingly, leaning of the center 33 on the same side with the current collecting portion 20 causes extremely large moment MB when the force F in the horizontal direction is applied, which could result in damage to the joint portion 31 and others.

To address the above, in the present embodiment, the center 33 of the first hole portion 25 and the first fixing portion 17 are made to lean oppositely from the center 32 of the joint of the current collecting portion 20 with respect to the short-side direction. Thus, even if the force F in the horizontal direction is applied to the second piece 15, the joint portion 31 is prevented from large damage. A position of the center 33 of the first hole portion 25 in the left and right direction in FIG. 5 is a position corresponding to an area where the graph of the moment MA and the graph of the moment MB intersect in FIG. 10. This position is the one having the smallest influence in total even in consideration of both the force F in the horizontal direction and the force G in the vertical direction.

The same applies to the position of the center 34 of the second hole portion 26. As similar to the position of the center 33, the position of the center 34 is preferably in a position leaning oppositely from the current collecting portion 20. However, the above-mentioned influence of the position of the center 33 of the first hole portion 25 is larger than the influence of the position of the center 34 of the second hole portion 26. This is because a distance of the center 33 from the current collecting portion 20 is shorter than the distance of the center 34 from the current collecting portion 20 in view of the longitudinal direction as explained above with FIG. 5.

The above-mentioned “center 32 of the joint of the current collecting portion 20” may be, for example, a geometric center of a region where the current collecting portion 20 covers in FIG. 5, in other words, a joint region of the current collecting portion to the second plate-like portion 19. Alternatively, the center 32 may be a point corresponding to both a center of the maximum range in the left and right direction and a center of the maximum range in the upper and lower direction of the region where the current collecting portion 20 covers.

Other than the above situation where the battery terminal 8 is subjected to stress, another situation is attaching process of a bus bar 11. The bus bar 11 is a conductive member to connect the batteries 1 with each other in a battery stack 35 shown in FIG. 11. The bus bar 11 in FIG. 11 connects the battery terminal 8 of one of adjacent batteries 1 with the battery terminal 9 of the other of the adjacent batteries 1. FIG. 11 only illustrates the two batteries 1, but in the actual battery stack 35, more numerous batteries 1 are connected in series by the bus bars 11.

Accordingly, there is a process of connecting the bus bar 11 to the battery terminal 8. In the battery terminal 8, the first plate-like portion 16 of the first piece 14 is the one to be connected with the bus bar 11. To be more specific, the first face 21 placed outwardly in a portion of the external terminal part 6 of the battery 1 is to be connected to the bus bar 11. Laser welding or other welding methods is used for connecting the first face 21 to the bus bar 11. Arrows L indicated in FIG. 11 indicate laser beam to be irradiated in the laser welding.

As shown in FIG. 12, in welding the bus bar 11, a part of the bus bar 11 and a part of the first plate-like portion 16 are locally molten to form a molten portion 36. At this timing of formation of the molten portion 36, portions of the bus bar 11 and the first plate-like portion 16 other than the molten portion 36 are considerably higher in their temperature than that of a normal state, and thus components are thermally expanded. Thereafter, the temperature of the bus bar 11 and the first plate-like portion 16 returns to the room temperature, and thus each size of the bus bar 11 and the first plate-like portion 16 returns to the original one before thermal expansion. The molten portion 36 gets resolidified at this time, so that the molten portion 36 and its surroundings are to strongly contract. The molten portion 36 then turns to a weld mark.

This strong contract of the molten portion 36 and its surroundings brings the first plate-like portion 16 and the bus bar 11 after welding into a state of being subjected to a tension T. This tension T causes stress of the battery terminal 8. However, in the present embodiment, the first piece 14 and the second piece 15 are connected by the two fixing portions 17 and 18. Accordingly, there are provided the two columnar portions of the first columnar portion 27 and the second columnar portion 29, achieving high rigidity in the battery terminal 8 as a whole. Therefore, even if the tension T due to the contract in resolidifying is applied, the joint portion 31 hardly suffers from degradation.

Further, the battery stack 35 may be used as an on-vehicle battery for vehicles. In this case, vibration during traveling of a vehicle could continuously bring stress on the battery terminal 8 in the battery 1. Even in that case, however, the configuration of the present embodiment can perform high stress resistance to the battery terminal 8. This is because, as mentioned above, the first fixing portion 17 and the second fixing portion 18 are arranged to lean oppositely to the current collecting portion 20 in the battery terminal 8. Further, another reason is that the two fixing portions 17 and 18 are provided in two points in the battery terminal 8.

As explained in detail above, according to the present embodiment, the battery terminal 8 of a two-piece configuration in the battery 1 is configured such that the first piece 14 and the second piece 15 are fixed by the two fixing portions of the first fixing portion 17 and the second fixing portion 18 and that the positions of these fixing portions in the short-side direction are arranged to lean oppositely to the current collecting portion 20. Thus, the battery terminal 8 and the battery 1 using the battery terminal 8 having resistance to the stress which might be caused after fixing the first piece 14 and the second piece 15 can be formed.

The present embodiment and examples are only illustration of the present disclosure and give no any limitation to the present disclosure. Accordingly, the present disclosure can be applied with various improvements and modifications without departing from the scope of the disclosure. For example, sizes of the first fixing portion 17 and the second fixing portion 18 may be different from each other. FIG. 13 shows such an example when seen from the same viewpoint with FIG. 5. In the example of FIG. 13, the second disk portion 30 of the second fixing portion 18 is larger than the first disk portion 28 of the first fixing portion 17. This size relation may be conversed. Further, the configuration may be modified by not only differentiating sizes in the first disk portion 28 and the second disk portion 30 but also differentiating sizes in a diameter of the first columnar portion 27 and a diameter of the second columnar portion 29. In this case, there is a difference also in a diameter of the first hole portion 25 and a diameter of the second hole portion 26.

Further, the first fixing portion 17 and the second fixing portion 18 may have different amount of leaning from the central position C in the short-side direction. Only the first fixing portion 17 has to lean oppositely from the current collecting portion 20, and the second fixing portion 18 may be positioned on the central position C or may lean in the same side with the current collecting portion 20. However, it is more advantageous that the second fixing portion 18 also leans oppositely from the current collecting portion 20.

A battery terminal to be adopted for the present disclosure may be not only for a negative electrode but also for a positive electrode. The present disclosure may be applied to both the negative electrode and the positive electrode. Materials for the first piece 14 and the second piece 15 are not limited to the above-mentioned aluminum and copper but may be other types of metal or alloy. The battery 1 may be selected from any type of batteries.

Further in the battery terminal according to the above aspect, preferably, the center of the second hole portion leans away from the central position of the short-side direction of the second plate-like portion oppositely to the center of the joint of the current collecting portion. Not only the first fixing portion but also the second fixing portion lean oppositely to the current collecting portion, thus achieving further preferable stress resistance.

A battery according to one aspect of the present disclosure comprises an exterior body, a power generation element housed inside the exterior body, and a terminal connected to the power generation element, wherein the terminal is the battery terminal according to claim 1. The stress resistance of the battery terminal is thus made high, so that the battery can have credibility.

Further in the battery according to the above-mentioned aspect, preferably, wherein the terminal is connected with a bus bar attached with other batteries. Connection of the bus bar causes stress on the battery terminal, and therefore application of the battery terminal having high stress resistance plays a significant role.

According to the present disclosure, a battery terminal having excellent stress resistance and a battery using the subject battery terminal are provided.

### REFERENCE SIGNS LIST

1 Battery
2 Exterior body
3 Power generation element
5 Lid
8 Battery terminal
9 Battery terminal
11 Bus bar
14 First piece
15 Second piece
16 First plate-like portion
17 First fixing portion
18 Second fixing portion
19 Second plate-like portion
20 Current collecting portion
21 First face of the first plate-like portion
22 Second face of the first plate-like portion
23 First face of the second plate-like portion
24 Second face of the second plate-like portion
25 First hole portion
26 Second hole portion
27 First columnar portion
28 First disk portion
29 Second columnar portion
30 Second disk portion
31 Joint portion
32 Center of a joint of the current collecting portion
33 Center of the first hole portion
34 Center of the second hole portion

What is claimed is:

1. A battery terminal for connecting a power generation element placed inside an exterior body of a battery and an external conductive member placed outside the exterior body,
the battery terminal being configured as a two-piece configuration including a first piece and a second piece which are formed of different conductive materials, wherein
the first piece includes:
a first plate-like portion provided with a first face and a second face, the first face to be arranged to face outward in the battery and to be connected to the external conductive member; and
a first fixing portion and a second fixing portion provided on the second face of the first plate-like portion and fixing the second piece,
the second piece includes:
a second plate-like portion provided with a first face and a second face, having a shape with a longitudinal direction and a short-side direction in planar view, and formed with a first hole portion and a second hole portion, the first face being arranged to face the second face of the first plate-like portion; and
a current collecting portion which is connected to a position leaning to one side from a center both in the longitudinal direction and in the short-side direction on the second face of the second plate-like portion and to be connected to the power generation element,
the first fixing portion includes:
a first columnar portion positioned in the first hole portion; and
a first disk portion expanding wider than the first columnar portion on the second face of the second plate-like portion,
the second fixing portion includes:
a second columnar portion positioned in the second hole portion; and
a second disk portion expanding wider than the second columnar portion on the second face of the second plate-like portion,
any one of at least a part of the first disk portion and at least a part of the second disk portion is joined to the second face of the second plate-like portion,
a center of the first hole portion is positioned between a center of a joint of the current collecting portion and a center of the second hole portion with respect to a longitudinal direction of the second plate-like portion, and
the center of the joint of the current collecting portion leans away from a central position of the short-side direction of the second plate-like portion, and the center of the first hole portion leans away from the central position of the short-side direction of the second plate-like portion oppositely to the center of the joint of the current collecting portion.

2. The battery terminal according to claim 1, wherein the center of the second hole portion leans away from the central position of the short-side direction of the second plate-like portion oppositely to the center of the joint of the current collecting portion.

3. A battery comprising an exterior body, a power generation element housed inside the exterior body, and a terminal connected to the power generation element, wherein the terminal is the battery terminal according to claim 1.

4. The battery according to claim 3, wherein the terminal is connected with a bus bar attached with other batteries.

5. A battery comprising an exterior body, a power generation element housed inside the exterior body, and a terminal connected to the power generation element, wherein the terminal is the battery terminal according to claim 2.

6. The battery according to claim 5, wherein the terminal is connected with a bus bar attached with other batteries.
